(19) United States
(12) Patent Application Publication
(10) Pub. No.: US 2006/0019833 A1
(43) Pub. Date: Jan. 26, 2006

(54) SUPERCONDUCTOR ELECTROMAGNETIC TRANSMITTER DEVICE

(76) Inventor: Arthur J. Lewis, Tahlequah, OK (US)

Correspondence Address: GREENBERG & LIEBERMAN, 314 PHILADELPHIA AVE., TAKOMA PARK, MD, 20912, US

(21) Appl. No.: 10/710,571

(22) Filed: Jul. 21, 2004

(51) Int. Cl. H01S 3/09

(52) U.S. Cl. 505/180

(57) ABSTRACT

The present invention is a super conductor electromagnetic transmitter device. This superconductor takes x amount of electrical current and amplifies it into an extremely powerful non-dissipating coherent signal.

### BACKGROUND OF INVENTION

The present invention is a device with the capability to produce and emit high energy coherent X-rays.

Today's commonly used energy sources continue to pose environmental risks, thus there is a constant search for the development of cleaner, more efficient energy sources. For instance the current energy sources use large nuclear reactors and or burning coal. The present invention is capable of nuclear fusion using only water, which is much more safe and clean than either one of the current methods. The present invention is also significantly smaller than current nuclear reactors.

Medical methods, however advanced and for the most part effective, are constantly in need of innovation and improvement, especially in the area cancer treatment and cures. For instance, the current cancer treatment involves killing the cancerous human cells using radiation. Unfortunately, this method, however effective, also kills some of the surrounding non-cancerous healthy cells as well. The present invention has the ability to target the cancerous cells leaving the healthy cell undamaged.

The progression of space equipment innovation is constantly increasing. It is believed that some time from now that a large asteroid could possibly collide with the earth and turn the earth into powder. The present invention can be used as a weapon against such an occurrence. The present invention can emit an extremely powerful beam with a damage capability more powerful than any nuclear warhead in the world. However the present invention can be used in any wartime situation as a weapon not just in outer space.

U.S. Pat. No. 5,015,920 Superconducting device for injection of electrons into electron tubes issued to Blanchard on Mar. 14, 1991 show one device, which injects electrons into another device. The principle is that of an electron gun contained within cathode ray tubes with exception that by using characteristic electrical properties in all superconductors, more efficient electron emission occurs from the superconductor bar. The present invention does not emit electrons but does emit electromagnetic wavelengths relative to beta emission and alpha emissions. It is an inherent problem, emitting particulate energies, that being like charges repel one another. This means that a maximum saturation of energy content will occur at both the source of generation and the emitted beam before the beam, simply stated, and disperses by saturation of particulate repulsion. Very high energy levels must be magnetically bottled if they are to propagate far. The present invention generates electromagnetic energy with wavelength of 10⁻⁸ and 10⁻¹¹ meters. Since the energy is generated within a self induced effect in the shape of the tube, no magnetic bottling effect energy need be applied. Since no particulate emission occurs within my device, the beam retains its coherent state without dispersal. The present invention weighs less than one ounce per transmitter cell.

U.S. Pat. No. 4,641,103 Microwave electron gun issued to Madey and Westenskow on Feb. 3, 1987 shows an electron gun using magnetic bottling effect in all conventional electron emitting devices even that of the infamous magnetron tube contained in microwave transmitters. It generates an electron beam which is considered particulate emission since electron mass (m sub e)=9.10953*10⁻³¹ kg. The same disadvantages with this device are as stated previously of weight, magnetic bottling power loss and maximum beam saturation levels exist.

U.S. Pat. No. 4,857,360 Process for the manufacture of NbN superconducting cavity resonators issued to Halbritter and Baumgartner on Aug. 15, 1989 only patents the process of coating a resonator surface with Niobium+Nitrogen chemical. The present invention uses the ceramic superconductor Y sub 1 Ba sub 2 Cu sub 3 O sub 7× superconductor and does not contain Niobium. It should probably be pointed out that my device may implement any superconductive material since the internal tube shape forms the Miessner effect magnetic bottling that shapes/maintains emission due to conservation of energy laws and parallel force relationship laws. Since no mass polarity exists within a true electromagnetic waveform, no mass repulsion exists causing beam dispersal during beam propagation.

NDN 202-0102-6570-3: LOCAL ORDER IN YBa2Cu3-yCoyO6+2× STUDIED BY ANOMALOUS DIFFUSE X-RAY SCATTERING, Citations from Energy Science and Technology (DOE): EDB discusses the doping of superconductive material causing it to enhance dispersion of X-rays. This is a direct inverse of the present invention does. There is no Cobalt within my device, since scattering/dispersal of beam contradicts coherency and the pertinent Superconductive Coherent X-ray transmitter (my invention) induces coherency, the two directly opposes each other and cannot be the same.

NDN 108-0701-0206-9 Status and perspectives of the next generation light sources. XFEL and ERL reflects upon production of coherent X-rays by using an electron linac, a rather massive setup and very power hungry so to speak. It also implements photon source production, which produces the secondary result of X-ray emission. It is not as efficient as the superconductive coherent X-ray transmitter device that relates to this patent search. Both mass and inefficient coherent X-ray generation are constraints not acceptable for application in many applications where coherent X-ray energy is required. This is particularly true were a defense against ballistic attack implemented as an orbital device which has significance to space launch mass/payload.

NDN 108-0648-8068-4 Pulse-power technology and its applications at LBT, Nagaoka, Citations from INSPEC: INS show Linear Accelerators of Terawatt power range are super-massive and may not be launched into space as of yet. The only uses known for this level of power are national defense and research into high energy physics. Constraints of this type of energy device are mass and energy loss relative to efficiency involved in powering an accelerator. The present invention maintains the X-ray beam at the core of emitter tube because once the X-ray energy is traveling straight down the tube, so to speak, it will stay in that state unless another perpendicular force disrupts it by stacking multiple transmitters end to end where the tube precisely matches at center, energy of 1012 joules may be attained/emitted. The weight difference of my device relative to the massive weight of a T watt Accelerator is nearly unimaginable with my transmitter nearly weighing nothing in comparison.

NDN 259-0721-8725-0 Energy recovery line acts as synchrotron radiation sources (invited), Citations from INSPEC: IN2 discusses electron accelerators and Linear accelerators. Unlike the present invention both are massive devices and both require massive energy input to attain inefficient beam output.

NDN 083-0472-3970-8 Transport anisotropy of in-plane c-axis aligned a-axis oriented YBa sub 2 Cu sub 3 Ox thin films, Citations from USG/NTIS: USG discusses X-ray diffraction relative to mass detection within material imbedded within some other material that prevents detection by other means such as spectral analysis. X-ray diffraction is being used to examine luggage in an airport for security purposes and is now experimented with for mineral analysis relative to mining operations. The superconducting thin films are a method of detecting X-rays that are diffracted and provide phase insight as to what the X-rays diffracted from. This discussion should be not included in relevant search since no relationship exists.

NDN 059-0118-6528-5 Accelerator and Fusion Research Division (Lawrence Berkeley Laboratory): 1984 Summary of Activities. Citations from US PATENT FULLTEXT: US3 discusses nuclear fusion research. Relationship to pertinent device is minimal since a superconducting particle accelerator often covers kilometers of area. The pertinent discussion could be involving the free-electron lasers discussed, but it is doubtful because a laser is an acronym: Light Amplification by Stimulated Emission of Radiation. The present invention generates E.M. radiation that is smaller in wavelength than U.V. light. And no photons are emitted.

Based on the aforementioned patents, there is an apparent need for a device capable of better and more efficient energy production, medical treatments and defense weapons. A device as such is presented here in the following:

### SUMMARY OF INVENTION

The present invention is a super conductor electromagnetic transmitter device. This superconductor takes x amount of electrical current and amplifies it into an extremely powerful non-dissipating coherent signal.

Many uses for high energy coherent X-rays are projected and include such areas as nuclear fusion research, Medical purposes, nuclear chemistry, stimulated fuel ignition systems, and were non-atmospheric generation of energy beam implemented, asteroid/comet destruction may be implemented were such considered a threat to National/Earth security, are a few that are evident.

The device used to implement coherent X-ray beam is a superconductive tube, one end open, the other closed with a superconductive reflector to E.M. emissions. The input E is attained by means of cross drilling a hole into tube with cross intersecting tube hole at its precise center. The cross hole is inserted with a non-conductive tube the diameter of which matches the central tube hole. Internal to the non-conductive tube is two anodes with a gap between anodes relative to desired frequency to be generated and the generated voltage. The emitter orifice was observed to be the best diameter at smaller than or equal to double the Meissner field expulsion state and no greater, Diameters greater than this allow incoherent emission.

Both emitter gap and high voltage application is required for E.M. frequency generation since the gap reflects resistance and application of high voltage, that of current flow. Upon application of 0.1 million volts with current of <10⁻⁶ amp, high energy electron volt radiation was observed having very penetrating state. This radiation was observed to radiate from aperture with no dispersal relative to emission in threedimensional space, producing dispersal of signal not relative to pie but actually less than 0.1 dispersal. Refer to graph in the appendix. It also penetrated conductive foil, establishing that it was not microwave in nature. Note: this level of energy is less than that required via X-ray tube generation of similar energy states.

### BRIEF DESCRIPTION OF DRAWINGS

FIG. 1 is an environmental view of a superconductor electromagnetic transmitter device.

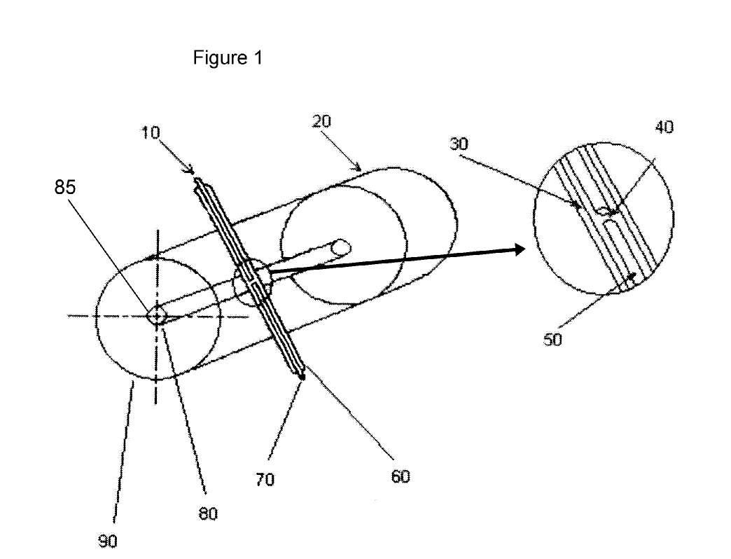

### DETAILED DESCRIPTION

The terminology needed for this application is as follows:

Miessner effect/field: The field of bipolar magnetic energy observed by applying magnetic energy to a superconductor. The effect was named after the person who first discovered it; Dr. Miessner.

Bipolar: Universal polarity, with superconductive related Miessner effect magnet levitation, bipolar state exists because the levitated magnet would otherwise just flip over and attract to the opposite charge were the magnet attempted to levitate over another magnet; General Chemistry, 2^{nd} edition, McQuarrie/Rock, (College Text).

Bipolar magnetic envelope: A type of magnetic envelope utilizing the Miessner effect evident in all superconductors; Arthur J. Lewis, lab results documented in logbook.

Self generating magnetic bottle: A state of magnetism which enhances the capture and propagation of radio wavelengths of electro magnetic form that is generated by the radio wavelength being produced. All particle accelerators use magnetic bottling to contain the energy or mass being accelerated. The energy forming these massive magnetic bottling effects is very great and very expensive. The weight and mass of the magnetic generators used to magnetically bottle energy is in the metric tons while a Superconductive transmitter device utilizes low energy generation Miessner effect to implement the bottling effect on energy and weighs 22 grams per miniature transmitter device; Arthur J. Lewis, Lab results contained in logbook entries of device development.

Electromagnetic Wavelength: Electron flow varying with time causes radio wave emission directly relative to the antenna emitting the signal. “In the case of a radio transmitter, it is hoped that the antenna efficiently causes the wave energy to be set free, The antenna is designed so as to not allow the electromagnetic wave energy to collapse back into the circuit”; Modern Electronic Communication, Gary M. Miller, 3^{rd} edition (College Text).

Electron flow: The flow of 6.242*10¹⁸ electrons=one Coulomb electron flow, one Coulomb flow per second=one amp; Boylestad, Introductory Circuit Analysis, 4^{th} edition (College Text).

Anode/Cathode: In alternating current applications the anode/cathode varies relative to polarity of voltage applied. This device may be used as alternating current where voltage polarity varies relative to time or as High Frequency Direct Current (HFDC) power source, where the polarity of anode/cathode remains the same or at lesser voltage relative to ground. In HFDC application the anode remains positive or zero while the cathode is negative or zero. In this HFDC application, polarity does not change. By definition the “anode is a positively charged electrode, as of an electron tube” and the “cathode is a negatively charged electrode, as of an electron tube”, Webster's II Dictionary; Boylestad, Introductory Circuit Analysis, 4^{th} edition (College Text).

Voltage: A charge of electromotive force; Webster's II Dictionary, Boylestad, Introductory Circuit Analysis, 4^{th} edition (College Text).

Wavelength: The distance in a periodic wave between two points of corresponding phases; Webster's II Dictionary; “A freely propagating electromagnetic energy as in radio waves having changing characteristics with analysis to time” Modern Electronic Communication, 3^{rd} edition, Gary M. Miller (College Text).

Microsecond: 0.000001 second; metric system time analysis.

Superconductor/superconductive: Any material that has zero resistance to current flow. Resistance to current flow associates to power loss since P=I²*R (Power=current squared*resistance), with no resistance equates to no power loss because X squared times zero equals zero no matter how big X is.

Frequency: f=1/t; Electronic Principles, 3^{rd} edition, Malvino, (College Text).

Inductors/Induction (L): A device/theory implementing the storage of electromotive force that is 180 degrees out of phase to the stimulating alternating current flow through coils of conductive wire wrapped around substrate. Voltage precedes current in analysis; Fundamentals of Electricity and Electronics, John E. Lackey, (College Text).

Capacitors/Capacitance (C): A device/theory implementing the storage of electric energy by negative ion storage in plates of conductive foil alternating with resistive to current flow film. Electromotive force is 180 degrees out of phase with stimulating electron current. Current precedes voltage in analysis; Fundamentals of Electricity and Electronics, John E. Lackey, (College Text).

L/C tank: f=1/(2*π*(sqr rt. (L*C))); this is an electronic formula for frequency evaluation relative to induction and capacitance. Inductors and Capacitors are 180 degree out of phase. While one is charging, the other discharges causing oscillation to occur relative to charge/discharge time constants relative to resistance; Fundamentals of Electricity and Electronics, John E. Lackey, (College Text).

Slope (dv/dt): Analysis method of Calculus relating to a line drawn as nearly equidistant from both sides of the curve as possible. This line is called tangent to the curve and may be analyzed by higher derivative analysis as being positive (slope increase) or negative (slope decrease) relative to axis evaluated at; Calculus with analytic geometry, Earl W. Swokowski, 3^{rd} edition, (College Text).

Reflects/Reflection: “Just as light waves are reflected by a mirror, radio waves are reflected by any conductive medium such as metal surfaces”. This reflection is caused by the wavelength of radio energy partially absorbing into the conductive surface which causes a same charge in metal surface to be formed. Reflection occurs off the same charge energy emanating from the conductive surface because like charges repel one another; Modern Electronic Communication, Gary M. Miller, 3^{rd} edition, (College Text). Reflection occurs with greater efficiency at higher frequency when reflecting off better conductive material, (material of lesser resistance to current flow). The best reflection of the highest grade of superconductivity has been observed in lab experiments pertaining to device development. Arthur J. Lewis, lab results contained in logbook.

Zero-space:Theoretical space described in Calculus as the limit as X approaches infinity of 1/X space; Calculus with analytic geometry, Earl W. Swokowski, 3^{rd} edition. In effect this is a zero diameter or space; however a maximum diameter of the wavelength desired may be allowed for efficient signal coherent propagation; Arthur J. Lewis, lab results contained in logbook.

Miessner bottling effect: The magnetic bottling effect that appears to occur relative to the generation of bipolar Miessner effect evident in superconductors. Arthur J. Lewis, lab results contained in logbook.

The present invention generates self generating magnetic bottling effect of all electromagnetic wavelengths internally formed by the emissions from the electron flow (arc) between the anode (10) and cathode (70) when high voltage is applied. Thermally tempered glass vacuum tubes (30, 60) reduce loss of energy associated to both oxidation of anode(10)/cathode(70) and signal arcing to the superconductor material. It is desired that as much energy as possible be applied to the signal generating arc gap for maximum efficiency. The wavelengths of energy generated a few microseconds after the field initialization energy are effectively bottled within the space contained within a bipolar magnetic envelope called the Miessner effect. Since the Miessner effect exists in the shape of the superconductor structure (90), internal tube shape (80), with one end an electromagnetic reflecting superconductor (20), the generated wavelengths are effectively bottled within the Miessner field and emitted out of the internal tube aperture (85) by reflection from reflecting superconductor (20). Reflecting superconductor (20) is removable as to allow several of the present inventions to be connected end to end to increase the power by 1 per unit. The principle concept is that the emitted wavelengths generated must be smaller than physical diameter of the interior of superconductor tube (80). All generated wavelengths longer than the diameter of superconductor tube (80) are simply shorted out within the superconductor walls and appear to add to the bipolar magnetic bottling effect. It further appears that these longer wavelengths tend to add to the oscillating effect of the electron flow occurring between the anode(10) and cathode (70). The present invention's size relates to the length of electromagnetic wavelengths being generated by proportion. Longer wavelength (lower frequency) of propagated radiowave requires larger transmitter device measurements, while shorter wavelength (higher frequency) devices need have much smaller measurements of anode (10)/cathode (70) gap distance (40) and internal tube aperture (85) diameter respectively.

Frequency oscillation of electron flow within a high voltage (100,000 volt or more) arc generates multiple wavelengths, the longest are absorbed into wall bipolar bottling magnetism generation, while the shorter are emitted by principles currently being applied in super colliders via magnetic bottling but with far more efficiency relating to power usage and weight reduction via Miessner effect formation of bipolar magnetism. The oscillation referred to occurs due to phase difference of inductors and capacitors. This is called an L/C tank in electronics and involves both inductors and capacitors ability to store/discharge electricity. Since inductors are 180 degrees out of phase with capacitors, so is the charge/discharge state. This causes an oscillation effect within electron arc between anode(10) and cathode(70) gap (40). The amount of induction/capacitance directly corresponds to the diameter of tube(80) and arc gap(40) distance respectively. The smaller the tube(80) diameter and arc gap(40), the smaller the oscillation induced within the present invention. Signal propagation occurs because the voltage applied causes current to flow across a high resistance barrier that is the gap between anode(10) and cathode(70). Since power equals the square of current multiplied to resistance, electromagnetic wavelengths are formed within the superconducting housing across the resistive arc gap (40). These generated wavelengths are then incorporated or emitted relative to the following concept description theories and occur at very high efficiency states because of the superconductive nature of device design.

In alternate embodiments superconductor structure (90) could be a square or triangle column as opposed to a cylinder. The anode (10) and cathode (70) can be inserted in a different location on the superconductor structure (90). Arc gap distance (40) between anode (10) and cathode (70) can be increased or decreased. However all of these alterations will effect the power and efficiency of the present invention and will not perform as desired.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

1. A superconductor electromagnetic transmitter device comprising:
a superconductor structure;
a superconductor reflector in communication with said superconductor structure;
a first tube in communication with said superconductor structure;
a second tube in communication with first tube;
an anode in communication with said second tube; and
a cathode in communication with said second tube.

2. The device of claim 1, wherein said superconductor structure is ceramic superconductor Y sub 1 Ba sub 2 Cu sub 3 O sub 7×.

3. The device of claim 1, wherein said superconductor structure has an aperture that extends through the length of the superconductor and out to the opposing side.

4. The device of claim 1, wherein said superconductor reflector is removable.

5. The device of claim 1, wherein said first tube is thermally tempered glass.

6. The device of claim 1, wherein said second tube is thermally tempered glass.

7. The device of claim 1, wherein the diameter of second tube is smaller than the diameter of the first tube.

8. The device of claim 1, wherein said second tube is inside first tube.

9. The device of claim 1, wherein between said anode and said cathode there is a space.

10. The device of claim 3, wherein the diameter of said aperture is consistent through the superconductor structure.

11. The device of claim 3, wherein the diameter of said aperture may vary depending on the desired size of wavelength.

12. The device of claim 9, wherein the measurement of said space may vary depending on the desired size of wavelength.

13. The device of claim 9, wherein the measurement of said space cannot be larger than the diameter of said aperture.
